(19) United States
(12) Patent Application Publication
(10) Pub. No.: US 2020/0335779 A1
(43) Pub. Date: Oct. 22, 2020

(54) METHOD OF PRODUCING THE SPHERICAL PRECURSOR CONTAINING LITHIUM IONS AS CATHODE MATERIAL FOR LITHIUM-ION BATTERY

(71) Applicant: GUS TECHNOLOGY CO., LTD., New Taipei City (TW)

(72) Inventors: Chung-Chieh CHANG, Taichung City (TW); Kuo-Wei YEH, Taipei City (TW)

(21) Appl. No.: 16/388,330

(22) Filed: Apr. 18, 2019

(51) Int. Cl. H01M 4/505; H01M 10/0525; H01M 4/1391; H01M 4/04; C01G 53/00

(52) U.S. Cl. CPC H01M 4/505; H01M 10/0525; H01M 4/1391; H01M 2004/028; C01G 53/44; C01P 2004/61; H01M 4/0471

(57) ABSTRACT

A method of producing the spherical precursor containing lithium ions as cathode material for lithium-ion battery, which includes the following steps. The metal salts containing lithium ions and acid radicals and water are thoroughly mixed to form an aqueous metal salt solution containing lithium ions. The aqueous metal salt solution containing lithium ions is fed into the hot-blast furnace chamber for the high temperature spray granulating equipment, and the atomizer sprays the aqueous metal salt solution containing lithium ions in the hot-blast furnace chamber, so as to form spherical liquid drops in particle size of 0.1 μm to 20 μm. The hot air at 300° C. to 1000° C. is supplied to the hot-blast furnace chamber, so that the atomized spherical liquid drops and hot air generate pyrolysis effect to pyrolyze the acid radicals, and the spherical liquid drops are dried instantaneously to form the spherical precursor containing lithium ions.

### BACKGROUND OF INVENTION

### 1. Field of the Invention

The present invention relates generally to a process technology for the precursor as cathode material for lithium-ion battery; and more particularly to an innovative method of producing the spherical precursor containing lithium ions as cathode material for lithium-ion battery.

### 2. Description of Related Art

The rechargeable lithium-ion battery has been extensively used in different portable electronic devices for high energy density. In terms of the electrode materials for lithium-ion battery, as the LiCoO₂ cathode material is quite expensive, it has been replaced by LNMCO type cathode material extensively. The LNMCO represents the lithium-nickel-manganese-cobalt oxide. The advantage of LNMCO type cathode material is that the cost of component M is much lower than Co, and the addition of lithium can increase the discharge capacity.

To produce a cathode material containing composite component, a special precursor is usually used. In order to obtain high performance without excessive sintering, the cathode precursor shall contain thoroughly mixed transition metal. Generally speaking, the mixed hydroxide with appropriate size and morphology is usually obtained by precipitation reaction through the following steps: (1) under the controlled pH condition, the sodium hydroxide flow, lithium hydroxide flow or potassium hydroxide flow and the mixed metal salt flow precipitate out the mixed hydroxide in the reactor; (2) the precursor suspension is removed and filtered; (3) the filtered wet cake is dried under the preset condition.

As stated above, the known precursor as cathode material for lithium-ion battery is prepared mainly by precipitation method. However, this manufacturing method is criticized by the circle for the wastewater resulted from reactive precipitation of OH⁻ in the process, the direct discharge of this wastewater can pollute the environment. If the industrial circles arrange the filter plants according to the government specified discharge standard, the cost will be increased greatly, mismatching the economic benefit of industry.

### BRIEF SUMMARY OF THE INVENTION

The primary object of the present invention is to provide a method of producing the spherical precursor containing lithium ions as cathode material for lithium-ion battery, the technical problem to be solved is to break through how to develop a new type of method of producing the precursor as cathode material for lithium-ion battery with more ideal practicability.

Based on the aforesaid object, the technical characteristics of problem solving of the present invention include the following steps: the metal salts containing lithium ions and acid radicals and water are thoroughly mixed, so as to prepare the aqueous metal salt solution containing lithium ions; the aqueous metal salt solution containing lithium ions is led in the hot-blast furnace chamber for high temperature spray granulating equipment, the atomizer sprays the aforesaid aqueous metal salt solution containing lithium ions in the hot-blast furnace chamber, so as to form spherical liquid drops in particle size of 0.1 μm to 20 μm. The hot air at 300° C. to 1000° C. is supplied to the hot-blast furnace chamber, so that the aforesaid atomized spherical liquid drops and hot air effect result in pyrolysis effect to pyrolyze acid radicals, and the spherical liquid drops are dried and set instantaneously, so as to form said spherical precursor containing lithium ions.

The main effects and advantages of the present invention include: First of all, the known technology uses OH⁻ precipitation method which requires a lot of water for reaction, and there will be wastewater after reaction. Based on the technical feature of the present invention that the acid radicals are pyrolyzed by the hot air in the hot-blast furnace chamber, the spherical liquid drops are dried and set instantaneously, and the water is evaporated, the spherical precursor containing lithium ions is completed. Therefore, the process only produces waste gas eventually, free of wastewater, the establishment charge of wastewater purification equipment is saved, and the water and energy are saved, so as to reduce the production cost of precursor containing lithium ions greatly for better economic benefit of the industry.

Secondly, the approximately spherical surface profile of said spherical precursor containing lithium ions of the present invention can greatly enlarge the area of contact with other constituents (e.g. lithium carbonate, lithium hydroxide) during subsequent sintering, the sintering quality and effect are gained greatly, the yield, efficiency and electricity storage capacity of the cathode material for lithium-ion battery and practical progressiveness are enhanced relatively.

Another object of the present invention is to cool the nozzle atomizer appropriately by another technical feature that the atomizer is set as a nozzle atomizer, and the nozzle atomizer is provided with a circulating cooling mechanism, so as to implement the advantage and practical progressiveness of preventing nozzle fouling.

The third object of the present invention is to knock down the material stuck on the hot-blast furnace chamber wall by another technical feature of a furnace wall hammering means in Step 3, so as to further enhance the end product yield of spherical precursor containing lithium ions and practical progressiveness.

### BRIEF DESCRIPTION OF THE DRAWINGS

FIG. 1 is the schematic diagram of the high temperature spray granulating equipment of the preferred embodiment of the present invention.

FIG. 2 is the schematic diagram of internal running state of high temperature spray granulating equipment of the preferred embodiment of the present invention.

FIG. 3 is the enlarged view of Region B in FIG. 2.

FIG. 4 is the enlarged sectional view of atomizer of the present invention.

FIG. 5 shows the embodiment of the circulating cooling mechanism for the atomizer of the present invention.

FIG. 6 is the scanning electron microscope analysis chart for the spherical precursor containing lithium ions of the present invention.

FIG. 7 is the scanning electron microscope analysis chart for the precursor of the known technology.

### DETAILED DESCRIPTION OF THE INVENTION

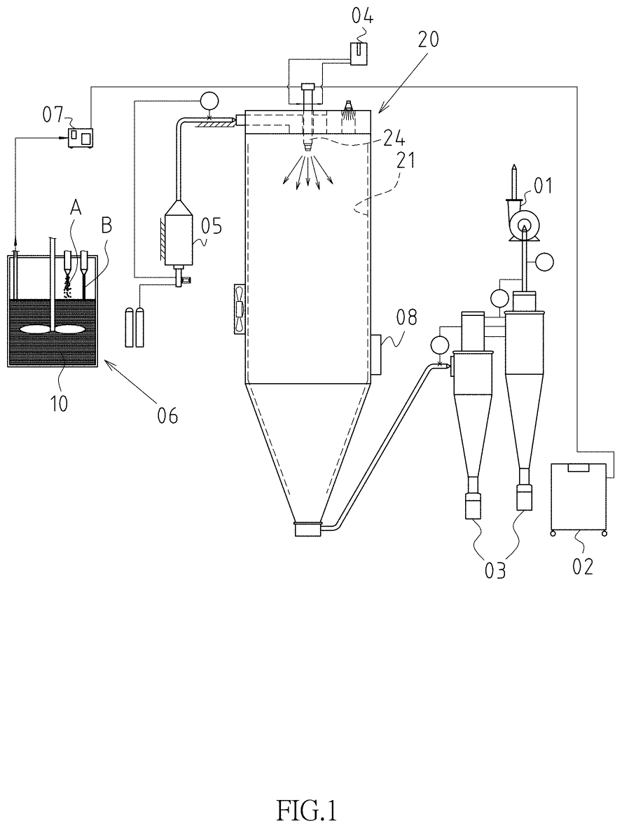

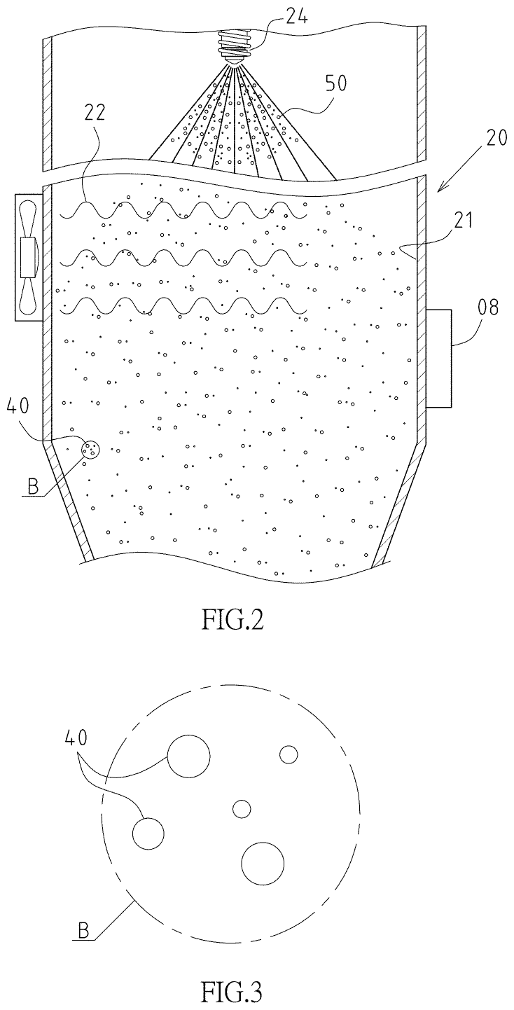

Referring to FIGS. 1 to 4 for the preferred embodiments of the method of producing the spherical precursor containing lithium ions as cathode material for lithium-ion battery of the present invention, but these embodiments are for illustration only, the patent application is not limited to this structure.

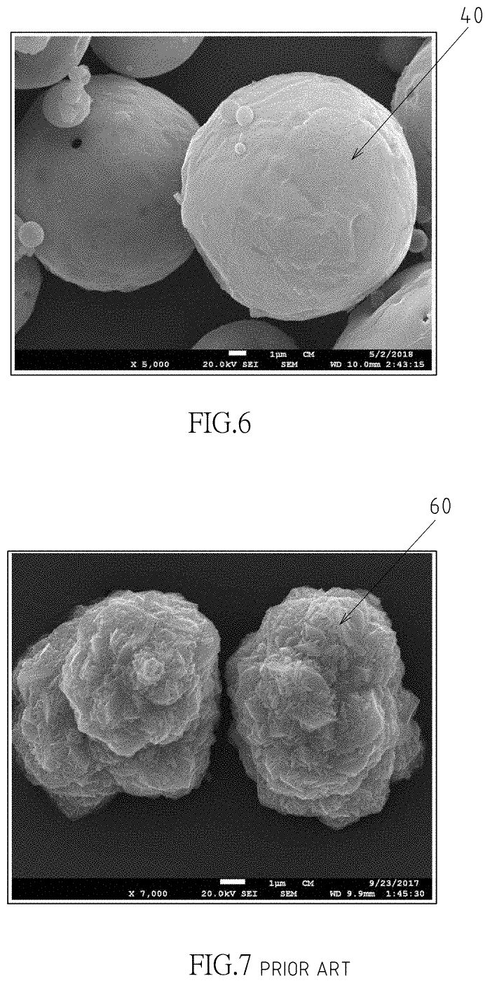

Said method of producing the spherical precursor containing lithium ions as cathode material for lithium-ion battery includes the following steps: Step 1, a metal salt containing lithium ions and acid radicals A and a water B are mixed thoroughly to form an aqueous metal salt solution containing lithium ions 10; Step 2, the aqueous metal salt solution containing lithium ions 10 is fed into a hot-blast furnace chamber 21 for a high temperature spray granulating equipment 20, and then an atomizer 24 for the high temperature spray granulating equipment 20 sprays the aqueous metal salt solution containing lithium ions 10 in the hot-blast furnace chamber 21, so as to form some spherical liquid drops 50 in particle size of 0.1 μm to 20 μm; (as shown in FIG. 3) Step 3, the hot air 22 at 300° C. to 1000° C. is supplied to the hot-blast furnace chamber 21, so that said atomized spherical liquid drops 50 and the hot air 22 generate pyrolysis effect to pyrolyze the acid radicals, and the spherical liquid drops 50 are dried instantaneously, so as to form said spherical precursor containing lithium ions 40 (as shown in FIG. 6)(Note: also known as spherical powder of metal oxide containing lithium ions).

Wherein the optimum range of the hot air 22 supplied to the hot-blast furnace chamber 21 is 400° C. to 800° C.

Furthermore, there is a gas-particle separation step (e.g. tubular dust collector 03, as shown in FIG. 1) following Step 3, so as to split the dry spherical precursor containing lithium ions 40 and waste gas. There is a particle size screening step after the gas-particle separation step, so as to screen the preset particle size of said spherical precursor containing lithium ions 40. There is a mixed sintering step after the particle size screening step, the spherical precursor containing lithium ions 40 is taken out and dried, and the dry spherical precursor containing lithium ions 40 is mixed with a Li₂CO₃ to obtain a metal oxide mixture. Afterwards, the metal oxide mixture is sintered at 600° C. to 950° C. to obtain an anode metal oxide material for lithium-ion battery, which has the following general expression

Li_{(0.92-0.99)}(Li_{w}Mn^{x}Co_{y}Ni_{z}Alᵣ)O₂, wherein w+x+y+z+r=1.

The spherical precursor containing lithium ions 40 disclosed by the present invention enables the precursor of anode metal oxide material for lithium-ion battery to contain lithium component at the very start, which has an approximately spherical surface profile. The advantage is that the yield of subsequent sintering can be increased greatly as the precursor contains highly uniform lithium ions. There is lithium loss during sintering of the known technology, whereas the present invention enables the precursor to contain lithium ions, the lithium wastage in subsequent sintering can be counted in, so as to remedy the loss resulted from the second sintering. Another advantage of the pyrolysis effect in the process of hot air 22 in the hot-blast furnace chamber 21 is that the spherical liquid drops 50 and hot air 22 result in pyrolysis effect to pyrolyze the acid radicals, so the pyrolysis effect is generated in the process of hot air 22, the spherical liquid drops 50 are dried instantaneously and the water is evaporated, there will be such waste gases as O₂, H₂O and NO₂, but there is no wastewater. The waste gases can be purified and discharged by simple air filtration units, the equipment cost is reduced greatly, and the present invention uses a little water, there is better environmentally economic benefit of water and energy saving (Note: the known technology uses OH⁻ precipitation method which requires a lot of water for reaction, and there is wastewater after reaction, the cleaning equipment cost is higher, and it is likely to result in environmental issues, e.g. pollution).

FIG. 6 is the scanning electron microscope analysis chart for the end product of said spherical precursor containing lithium ions 40 of the present invention. The surface of the spherical precursor containing lithium ions 40 disclosed in this case is approximately spherical and smooth, so the powder stacking density can be increased effectively in subsequent rolling process, the quality and effect of the finished positive plate of battery are gained greatly. FIG. 7 is the scanning electron microscope analysis chart for the end product of the precursor 60 of the known technology, the surface is much rougher than the present invention and the profile fluctuates largely. Therefore, the powder stacking density is poor in the rolling process, and the quality and effect of the finished positive plate of battery are worse.

Wherein the metal in said metal salts containing lithium ions and acid radicals A is either combination of nickel, cobalt, aluminum and lithium or nickel, cobalt, manganese and lithium; the salts in the metal salts containing lithium ions A is any one of nitrate (NO₃⁻), sulfate (SO₄²⁻) and carbonate (CO₃²⁻).

Wherein said aqueous metal salt solution containing lithium ions 10 in Step 1 has the following general expression: ((1+w)Li(NO₃)₍ₛ₎+xMn(NO₃)₂₍ₛ₎+yCo(NO₃)₂₍ₛ₎+zNi(NO₃)₂₍ₛ₎+rAl(NO₃)₃₍ₛ₎)+H₂O→((1+w)Li⁺+xMn²⁺+yCo²⁺+zNi²⁺+rAl³⁺)₍ₗ₎+(1+w+2x+2y+2z+3r)(NO₃)⁻₍ₗ₎+H₂O₍ₗ₎; And the spherical precursor containing lithium ions 40 formed after pyrolysis in Step 3 has the following general expression: Li_{(0.95-1)}(Li_{w}MnₓCo_{y}Ni_{z}Alᵣ)O₂₍ₛ₎+(1+w+2x+2y+2z+3r)NO_{2(g)}+H₂O_{(g)}

In the above general expressions, w+x+y+z+r=1. According to the above general expressions, when said spherical liquid drops 50 and hot air 22 generate pyrolysis effect, the acid radicals are pyrolyzed (2NO₃⁻→2NO₂+O₂), it is obvious that the final byproduct of the present invention is merely gas.

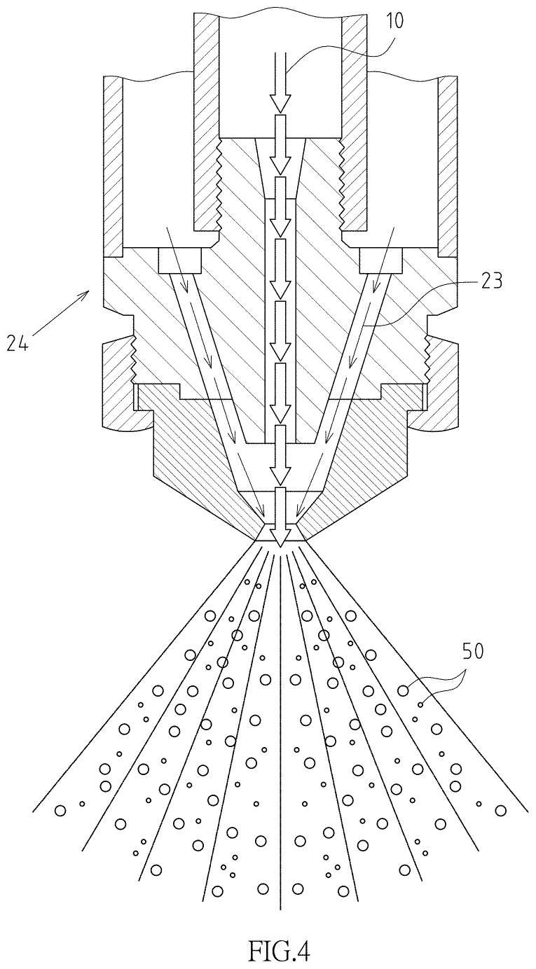

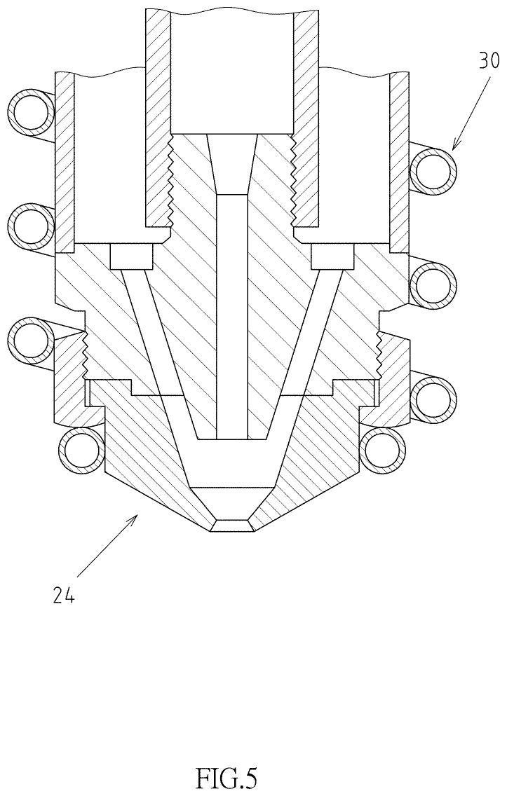

As shown in FIG. 4, in this case, the atomizer 24 for the high temperature spray granulating equipment 20 is a nozzle atomizer. This case indicates that said nozzle atomizer can be any form of two-fluid, three-fluid and four-fluid air flow channels. As shown in FIG. 5, in this case, the atomizer 24 is provided with a circulating cooling mechanism 30. Said circulating cooling mechanism 30 is provided in this case, because the temperature of hot-blast furnace chamber 21 is very high, it shall be cooled appropriately to prevent nozzle fouling. The atomizer 24 for the high temperature spray granulating equipment 20 can be an ultrasonic atomizer (Note: not shown in the figure).

In addition, in the course of Step 3, a furnace wall hammering means can be performed (e.g. actuating the air hammer 08 to knock on the furnace wall), to knock down the material stuck on the furnace wall of the hot-blast furnace chamber 21, so as to increase the product yield of spherical precursor containing lithium ions 40.

In specific application of the method of producing the spherical precursor containing lithium ions as cathode material for lithium-ion battery disclosed in the present invention, in terms of further details of equipments and technical means, as shown in FIG. 1, the embodiment procedure is described below. First of all, an amount of (lithium nitrate, nickel nitrate, cobalt nitrate and manganous nitrate) or (lithium nitrate, nickel nitrate, cobalt nitrate and aluminum nitrate) is poured into the agitator tank 06, stirred in the agitator tank 06 for over 30 minutes, the stirred liquid forms an aqueous metal salt solution containing lithium ions 10. Afterwards, the following equipment is actuated for operation.
(1) The exhaust fan 01 is actuated and set as 70 Hz;
(2) The air solenoid valve 02 is actuated to operate the atomizer 24;
(3) The cooling water tank 04 is actuated to avoid too high heating temperature of hot-blast furnace chamber 21;
(4) The gas burner 05 is actuated to heat up the hot-blast furnace chamber 21, the heating process needs 1.5 to 2 hours, the temperature inside the hot-blast furnace chamber 21 is kept at 300-1000° C. (optimum is 400-800), the outlet temperature is lower than 180° C., the static pressure of hot-blast furnace chamber 21 is 10-15 mm Aq, the internal pressure of atomizer 24 is 2-3 kg/cm²;

As stated above, when the hot-blast furnace chamber 21 is heated, the dosing pump 07 is actuated, and the flow is set as 20 ml/min to push aqueous metal salt solution containing lithium ions 10 into the high temperature spray granulating equipment 20, and the temperature inside the hot-blast furnace chamber 21 is kept higher than 450° C. When the aqueous metal salt solution containing lithium ions 10 is fed into the high temperature spray granulating equipment 20, the aqueous metal salt solution containing lithium ions 10 ejected from the nozzle of atomizer 24 is mixed with the high pressure gas 23 delivered through another channel in the atomizer 24 (as shown in FIG. 4). At this moment, the erupted aqueous metal salt solution containing lithium ions 10 is homogenized and granulated by the strong impact and turbulence effects of high pressure gas 23, so as to form spherical liquid drops 50 which are sprayed into the hot-blast furnace chamber 21. The hot air 22 in the hot-blast furnace chamber 21 dries the spherical liquid drops 50 instantaneously to form spherical precursor containing lithium ions 40. At this point, the air hammer 08 is actuated to knock down the spherical precursor containing lithium ions 40 stuck on the furnace wall of hot-blast furnace chamber 21. Finally, the spherical precursor containing lithium ions 40 is collected by tubular dust collector 03. The waste gas generated in the process is discharged by the exhaust fan 01. The dry spherical precursor containing lithium ions 40 is mixed with Li₂CO₃ to obtain a metal oxide mixture. Finally, the metal oxide mixture is sintered at 600° C. to 950° C., so as to obtain an anode metal oxide material for lithium-ion battery Li_{(0.92-0.99)}(Li_{w}MnₓCo_{y}Ni_{z}Alᵣ)O₂, wherein w+x+y+z+r=1.

Furthermore, the specific implementation of the forming method disclosed in the present invention varies with various countries' standard process specifications. For example, Japan and European countries usually use NCA process, the aqueous metal salt solution contains NiCoAl (nickel, cobalt, aluminum); and Taiwan, Chinese Mainland and Korea usually use NCM process, the aqueous metal salt solution contains NiCoMn (nickel, cobalt, manganese). The specific component mix proportions and brief process steps of the forming technique for spherical precursor containing lithium ions as cathode material for lithium-ion battery disclosed in the present invention for different process infrastructures are described below in embodiments:

### Embodiment 1-1

The lithium nitrate, nickel nitrate, cobalt nitrate and manganous nitrate are taken according to mole ratio 1.08:0.34:0.08:0.5 and thoroughly mixed and dissolved in water to form the aqueous metal salt solution containing lithium ions 10. The addition includes 161.88 g lithium nitrate, 214.93 g nickel nitrate, 50.61 g cobalt nitrate and 311.89 g manganous nitrate, and then the aqueous metal salt solution containing lithium ions 10 is fed into the hot-blast furnace chamber 21 of high temperature spray granulating equipment 20, the optimum temperature of hot-blast furnace chamber 21 is controlled at 400-800° C. to form the spherical precursor containing lithium ions 40 Li_{(0.95-1)}(Li_{0.08}Ni_{0.34}Co_{0.08}Mn_{0.5})O₂. The spherical precursor containing lithium ions 40 is sintered at 900° C. for 10 hours, the anode metal oxide material for the lithium-ion battery Li_{(0.92-0.99)}(Li_{0.08}Ni_{0.34}Co_{0.08}Mn_{0.5})O₂ is obtained, and the material mix proportions are compiled in Table 1-1.

### Embodiment 1-2

The anode metal oxide material for lithium-ion battery is prepared in the same way of <Embodiment 1-1>, the main difference is that the lithium nitrate, nickel nitrate, cobalt nitrate and manganous nitrate are prepared according to mole ratio 1.03:0.80:0.10:0.07, the addition includes 154.39 g lithium nitrate, 505.72 g nickel nitrate, 63.27 g cobalt nitrate and 43.66 g manganous nitrate, the spherical precursor containing lithium ions 40 Li_{(0.95-1)}(Li_{0.03}Ni_{0.8}Co_{0.1}Mn_{0.07})O₂ is formed. The spherical precursor containing lithium ions 40 is sintered at 800° C. for 10 hours, the anode metal oxide material for lithium-ion battery Li_{(0.92-0.99)}(Li_{0.03}Ni_{0.8}Co_{0.1}Mn_{0.07})O₂ can be obtained, and the material mix proportions are collected in Table 1-2.

### Embodiment 1-3

The anode metal oxide material for lithium-ion battery is prepared in the same way of <Embodiment 1-1>, the main difference is that the lithium nitrate, nickel nitrate, cobalt nitrate and aluminum nitrate are prepared according to mole ratio 1.01:0.85:0.11:0.03, the addition includes 70.15 g lithium nitrate, 248.97 g nickel nitrate, 32.25 g cobalt nitrate and 11.34 g aluminum nitrate, the spherical precursor containing lithium ions 40 Li_{(0.95-1)}(Li_{0.01}Ni_{0.85}Co_{0.11}Al_{0.03})O₂ is formed. The spherical precursor containing lithium ions 40 is sintered at 800° C. for 10 hours, the anode metal oxide material for lithium-ion battery Li_{(0.92-0.99)}(Li_{0.01}Ni^{0.85}Co^{0.11}Al_{0.03})O₂ can be obtained, and the material mix proportions are collected in Table 1-3.

TABLE 1
Mix proportions for producing spherical precursor containing
lithium ions Li (Li_{w}MnₓCo_{y}Ni_{z}Alᵣ)O₂ powder solution

| | | Metal molar | Nitric acid metallic |
|---|---|---|---|
| | Metal | ratio | solution weight (g) |
| Embodiment | Nickel | 0.34 | 214.93 |
| 1-1 | Cobalt | 0.08 | 50.61 |
| | Manganese | 0.5 | 311.89 |
| | Lithium | 1.08 | 161.88 |
| Embodiment | Nickel | 0.8 | 505.72 |
| 1-2 | Cobalt | 0.1 | 63.27 |
| | Manganese | 0.07 | 43.66 |
| | Lithium | 1.03 | 154.39 |
| Embodiment | Nickel | 0.85 | 248.97 |
| 1-3 | Cobalt | 0.11 | 32.25 |
| | Manganese | 0.03 | 11.34 |
| | Lithium | 1.01 | 70.15 |

1. A method of producing the spherical precursor containing lithium ions as cathode material for lithium-ion battery includes the following steps:
Step 1: A metal salt containing lithium ions and acid radicals A and a water B are thoroughly mixed to form an aqueous metal salt solution containing lithium ions;
Step 2: The aqueous metal salt solution containing lithium ions is fed into a hot-blast furnace chamber for a high temperature spray granulating equipment, and then an atomizer for the high temperature spray granulating equipment sprays said aqueous metal salt solution containing lithium ions in the hot-blast furnace chamber, so as to form spherical liquid drops in particle size of 0.1 μm to 20 μm;
Step 3: Hot air at 300° C. to 1000° C. is supplied to the hot-blast furnace chamber, so that said atomized spherical liquid drops and the hot air generate pyrolysis effect to pyrolyze the acid radicals, and the spherical liquid drops are dried instantaneously to form said spherical precursor containing lithium ions.

2. The method of producing the spherical precursor containing lithium ions as cathode material for lithium-ion battery defined in claim 1, wherein the metal in the metal salts containing lithium ions and acid radicals A is either combination of nickel, cobalt, aluminum and lithium or nickel, cobalt, manganese and lithium; the salts in the metal salts containing lithium ions A is any one of nitrate, sulfate and carbonate.

3. The method of producing the spherical precursor containing lithium ions as cathode material for lithium-ion battery defined in claim 2, wherein said aqueous metal salt solution containing lithium ions in Step 1 has the following general expression:
((1+w)Li⁺+xMn²⁺yCo²⁺+zNi²⁺+rAl³⁺)₍ₗ₎+(1+w+2x+2y+2z+3r)(NO₃₎⁻₍ₗ₎+H₂O₍ₗ₎
the spherical precursor containing lithium ions 40 formed in Step 3 has the following general expression:
Li_{(0.95-1)}(Li_{w}MnₓCo_{y}Ni_{z}Alᵣ)O₂₍ₛ₎+(1+w+2x+2y+2z+3r)NO_{2(g)}+H₂O_{(g)}
in the above general expressions, w+x+y+z+r=1.

4. The method of producing the spherical precursor containing lithium ions as cathode material for lithium-ion battery defined in claim 3, wherein the atomizer for the high temperature spray granulating equipment is a nozzle atomizer; the nozzle atomizer is any form of two-fluid, three-fluid and four-fluid air flow channels.

5. The method of producing the spherical precursor containing lithium ions as cathode material for lithium-ion battery defined in claim 4 wherein the atomizer is provided with a circulating cooling mechanism.

6. The method of producing the spherical precursor containing lithium ions as cathode material for lithium-ion battery defined in claim 3, wherein the atomizer for the high temperature spray granulating equipment is an ultrasonic atomizer.

7. The method of producing the spherical precursor containing lithium ions as cathode material for lithium-ion battery defined in claim 4, wherein the optimum range of the hot air supplied to the hot-blast furnace chamber is 400° C. to 800° C.

8. The method of producing the spherical precursor containing lithium ions as cathode material for lithium-ion battery defined in claim 7, wherein a furnace wall hammering means can be performed in Step 3 to knock down the material stuck on the furnace wall of the hot-blast furnace chamber.

9. The method of producing the spherical precursor containing lithium ions as cathode material for lithium-ion battery defined in claim 8, wherein there is a gas-particle separation step after Step 3, so as to split the dry spherical precursor containing lithium ions and waste gas.

10. The method of producing the spherical precursor containing lithium ions as cathode material for lithium-ion battery defined in claim 9, wherein there is a particle size screening step after the gas-particle separation step, so as to screen the preset particle size of said spherical precursor containing lithium ions.

11. The method of producing the spherical precursor containing lithium ions as cathode material for lithium-ion battery defined in claim 9, wherein there is a mixed sintering step after the particle size screening step, the spherical precursor containing lithium ions 40 is taken out and dried, and then the dry spherical precursor containing lithium ions 40 is mixed with a Li₂CO₃ to obtain a metal oxide mixture, and the metal oxide mixture is sintered at 600° C. to 950° C. to obtain an anode metal oxide material for lithium-ion battery, which has general expression Li_{(0.92-0.99)}(Li_{w}MnₓCo_{y}Ni_{z}Alᵣ)O₂, wherein w+x+y+z+r=1.
